(19) United States
(12) Patent Application Publication
(10) Pub. No.: US 2010/0241639 A1
(43) Pub. Date: Sep. 23, 2010

(54) APPARATUS AND METHODS FOR CONCEPT-CENTRIC INFORMATION EXTRACTION

(75) Inventors: Daniel Kifer, State College, PA (US); Srujana Merugu, Sunnyvale, CA (US); Ankur Jain, Bangalore (IN); Sathiya Keerthi Selvaraj, Cupertino, CA (US); Alok S. Kirpal, Sunnyvale, CA (US); Philip L. Bohannon, Cupertino, CA (US); Raghu Ramakrishnan, San Jose, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/408,450

(22) Filed: Mar. 20, 2009

(51) Int. Cl. G06F 17/30

(52) U.S. Cl. 707/754; 707/E17.071

(57) ABSTRACT

Disclosed are methods and apparatus for extracting (or annotating) structured information from web content. Web content of interest from a particular domain is represented as one or more tree instances having a plurality of branching nodes that each correspond to a web object such that the tree instances correspond to one or more structured data instances. The particular domain is associated with domain knowledge that includes one or more presentation rulesets that each specifies a particular structure for a set of data instances, a domain-specific concept labeler, one or more specified properties of the web objects in the tree instances, and a concept schema that specifies a representation of the data to be extracted from the web content. A structured data instance that conforms to the concept schema is extracted from the one or more tree instances based on the domain knowledge for the particular domain. Extraction of the structured data instances is accomplished by (i) using the domain-specific concept labeler to annotate a subset of nodes of the tree instances; and (ii) using a locally adaptive concept annotator to extract the structured data instances based on the annotated segments and the local properties associated with such annotated segments. The extracted structured data instance is stored as structured output records in a database.

### BACKGROUND OF THE INVENTION

The present invention is related to techniques and mechanisms for extracting structured information from web pages and other such types of documents.

Over the last decade, the web has transformed into a massive repository of unstructured and semi-structured information, as well as a gateway into numerous databases. A significant portion of this information occurs in the form of lists of various types of records on html (hyper text markup language) web pages, where each record corresponds to a set of attributes. For example, a store record may be composed of attributes such as store name, address and phone number. Typically, these record lists exhibit a wide amount of variability in the number, type, ordering and presentation of records and attributes. For example, a web page may correspond to a particular semantic category or “domain”, e.g., store information, events, product information. The term “domain” is used herein to refer to a semantic category and it is not to be confused with a website domain. By way of specific examples, a particular record list for a particular domain may take the form of a list of store locator results, shopping products, or events from a calendar, and each of these list types can include various attributes in different orders. Record lists can also be arranged at various locations on the web pages and such web pages may include a large number and type of other non-list or irrelevant list information (e.g., lists of navigation links and advertisements). A particular record list may have an irregular or nested format. In cases involving a large number of similar “list type” pages such as store locator results of a single chain, the content is usually retrieved from a backend databases and displayed using html scripts and style sheets, whereas in other cases content is manually created.

It is currently very difficult to extract structured data records from such diversely formatted record lists. Currently, custom programs are written to extract the record lists or other structured information from individual web sites, which uses a consistent format and these cannot be readily generalized to other web sites without human input.

In light of the variability of such semi-structured information arrangements on web pages, an intelligent mechanism for converting such diverse semi-structured information into more structured database records would be beneficial.

### SUMMARY OF THE INVENTION

In certain embodiments, a method of extracting (or annotating) structured information from web content is disclosed. Web content of interest from a particular domain is represented as one or more tree instances having a plurality of branching nodes that each correspond to a web object such that the tree instances correspond to one or more structured data instances. The particular domain is associated with domain knowledge that includes one or more presentation rulesets that each specifies a particular structure for a set of data instances, a domain-specific concept labeler, one or more specified properties of the web objects in the tree instances, and a concept schema that specifies a representation of the data to be extracted from the web content. A structured data instance that conforms to the concept schema is extracted from the one or more tree instances based on the domain knowledge for the particular domain. Extraction of the structured data instances is accomplished by (i) using the domain-specific concept labeler to annotate a subset of nodes of the tree instances; and (ii) using a locally adaptive concept annotator to extract the structured data instances based on the annotated segments and the local properties associated with such annotated segments. The extracted structured data instance is stored as structured output records in a database.

In a specific implementation, using the locally adaptive concept annotator is accomplished by (i) generating a candidate pool of annotatable segments of the one or more tree instances for the concept schema; (ii) identifying a set of predictive local features of the annotatable segments, (iii) learning a model for a locally adaptive concept annotator based on the identified set of predictive local features and the annotated segments, and (iv) executing the learned model on the candidate annotatable segments. In another embodiment, the extraction is accomplished by (a) choosing a set of selected informative queries for annotations, (b) selecting and executing a current extraction operator from a plurality of operators for receiving the selected set of informative queries and producing a set of current annotations, wherein the selection of the current extraction operation is based on which operators have their input conditions met by a current annotated state of the tree instances and can produce the annotations of the selected informative queries, and (c) repeating operations (a) and (b) until a structured data instance that conforms to the concept schema is obtained.

In a further aspect, the concept schema corresponds to a labeled tree having a plurality of nodes representing named concepts and a plurality of leaf nodes representing atomic concepts. In another embodiment, the concept schema specifies one or more atomic concepts or attributes that form part of a particular entity record and the extracted structured data instances are in the form of a list of records that each have a plurality of attribute and value pairs. In yet another aspect, the one or more presentation rulesets each specify hierarchical and ordering relations between instances of a plurality of presentation groups in the one or more tree instances that facilitate mapping of annotated atomic values to concepts in the concept schema. In a further aspect, the presentation rulesets are specified as a set of context-free grammars with respect to the one or more tree instances.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of certain embodiments of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a diagrammatic representation of a typical extraction scenario.

FIG. 3A shows an example logical representation for the running example of FIG. 2.

FIG. 3B shows an example of a concept schema.

FIG. 3C shows a representation of the structured output records associated with the running example of FIG. 2.

FIG. 3D shows two specific presentation rulesets corresponding to our running example of FIG. 2.

FIG. 4A depicts a basic architecture of a concept-centric extraction system in accordance with one embodiment of the present invention.

FIG. 4B is a high level flow chart illustrating a concept-centric procedure for extracting information from web content in accordance with one embodiment of the present invention.

FIG. 5 is a representative diagram of an example workflow for list extraction, which utilizes adaptive local learning, in accordance with a specific implementation of the present invention.

FIG. 6 is a diagrammatic representation of a concept-centric list extraction system in accordance with a specific implementation of the present invention.

FIG. 7 illustrates a typical web page that pertains to a restaurant domain.

FIG. 8 illustrates an example of a nested list for a conference.

FIG. 9 is a diagrammatic representation of a DOM (document object model) tree portion that corresponds to a list from a web page.

FIG. 10 illustrates an example computer system in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with specific embodiments, it will be understood that it is not intended to limit the invention to these embodiments. On the contrary, the invention is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Due to its potential benefits, the record extraction problem has received a lot of interest recently, and approaches fall into three general categories: wrapper induction, supervised learning methods, and unsupervised methods.

Wrapper induction methods involve learning, from a pool of positive and negative examples, page or site specific regular expressions or XPath-based (eXtensible Markup Language or XML Path Language-based) patterns to label data. For example, it may be determined that the show time for “Dark Knight” on localtheatre.com occurs at a particular XPath. Supervised category-specific methods such as those based on conditional random fields learn site-independent parametric models, using the specified predictive features and hand-labeled examples for each concept in a representative set of web pages. For example, since show times are distinctive, such a model may be trained to recognize them, without having to determine a pattern for every site.

Both techniques tend to be prohibitively expensive to scale, for two key reasons: 1) the need for perfectly labeled training examples, and 2) the relatively brittle nature of the model that is learned. In the case of wrappers, while few examples are generally needed per site, there are too many sites, and these sites may frequently make small structure changes, invalidating the wrapper. Supervised models would not seem to have this problem, since they work across sites. However, it is necessary to provide a “representative” sample of data for training, which can be an ill-defined and expensive task when working on the web. Further, once this sample is gathered, perfect training-labels on that sample need to again be provided, a labor-intensive and thus, costly process.

Unsupervised methods may appear to remove the costs of sample gathering and labeling. This cost reduction may be accomplished by using visual features and the periodicity of structure on a page to label data. However, most techniques are quite limited in the content they can gather, since overly strong assumptions again lead to limited application, and generally with no means to fix problems by adding supervision. For example, even if the movie show times appear in a nicely-formatted list that is recognizable by unsupervised techniques, these techniques tend to be confused by the many other lists on the web page (e.g. navigation links, sidebars, etc.)

In specific embodiments of the present invention, a framework for “concept-centric” extraction and an instantiation for the special case of record-list extraction are provided. This framework can provide most of the ability of wrappers and supervised techniques to label specific information on web pages with far lower cost, while retaining the ability of the unsupervised techniques to extract from a huge number of differently formatted pages so as to work at web-scale.

Although certain embodiments are described herein in relation to a list extraction system in relation to textual attribute-values of list records, it should be apparent that an extraction system may also be provided for other types of attributes, such as links to audiovisual objects (e.g., photographs, music or video clips). It should also be noted that embodiments of the invention are contemplated in which the presentation of the underlying web page is largely unaffected by the overlying list mining system. That is, the compiled records may be used independently of the web page presentation. In alternative embodiments, presentation of the web page, which is being analyzed for information extraction, may be adjusted or altered based on the extracted information.

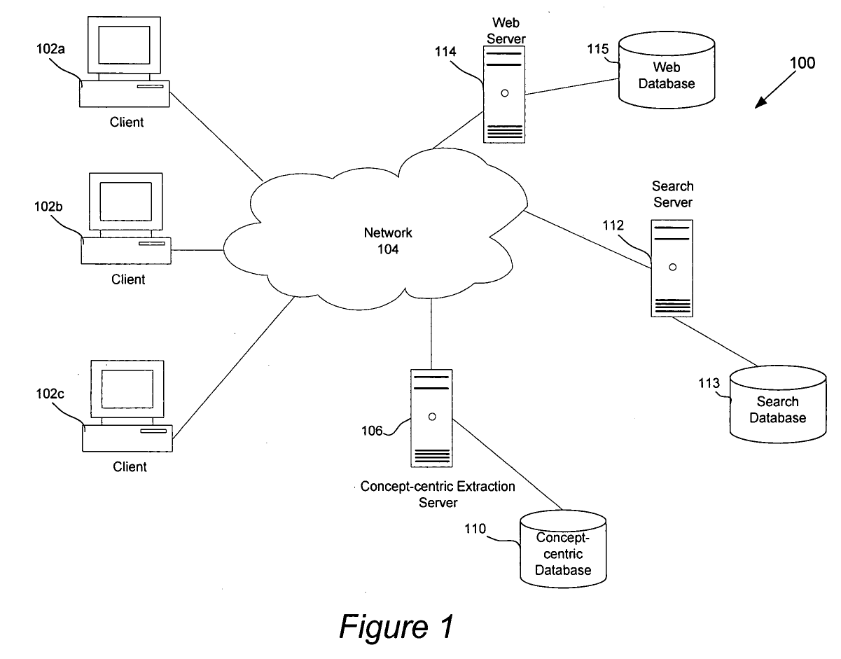

Prior to describing detailed mechanisms for extracting lists of interest, a high level computer network environment will first be briefly described to provide an example context for practicing techniques of the present invention. FIG. 1 illustrates an example network segment 100 in which the present invention may be implemented in accordance with one embodiment of the present invention. As shown, a plurality of clients 102 may access a search application, for example, on search server 112 via network 104 and/or access a web service, for example, on web server 114. The network may take any suitable form, such as a wide area network or Internet and/or one or more local area networks (LAN's). The network 104 may include any suitable number and type of devices, e.g., routers and switches, for forwarding search or web object requests from each client to the search or web application and forwarding search or web results back to the requesting clients or for forwarding data between various servers.

Embodiments of the present invention may also be practiced in a wide variety of network environments (represented by network 104) including, for example, TCP/IP-based networks (e.g., Rate Control Protocol or RCP, Transport Control Protocol or TCP, Fast TCP, Stream-based TCP/IP or STCP, eXplicit Control Protocol or XCP, etc.), telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The search server 112 may implement a search application. A search application generally allows a user (human or automated entity) to search for web objects (i.e., web documents, videos, images, etc.) that are accessible via network 104 and related to one or more search terms. In one search application, search terms may be entered by a user in any manner. For example, the search application may present a web page having any input mechanism to the client (e.g., on the client's device) so the client can enter a query having one or more search term(s). In a specific implementation, the search application presents a text input box into which a user may type any number of search terms.

Embodiments of the present invention may be employed with respect to web pages obtained from web server applications or generated from any search application, such as general search applications that include Yahoo! Search, Google, Altavista, Ask Jeeves, etc or specific search applications that include Yelp (e.g., a product and services search engine), Amazon (e.g., a product search engine), etc. The search applications may be implemented on any number of servers although only a single search server 112 is illustrated for clarity and simplification of the description.

When a search is initiated to a search server 112, such server then obtains a plurality of web objects that relate to the query input. In a search application, these web objects can be found via any number of servers (e.g., web server 114) and usually enter the search server 112 via a crawling and indexing pipeline possibly performed by a different set of computers (not shown).

The search server 112 (or servers) may have access to one or more search database(s) 114 into which search information is retained. For example, each time a user initiates a search query with one or more search terms and/or performs a search based on such search query, information regarding such search may be retained in the search database(s) 114. Likewise, each web server 114 may have access to one or more web database(s) 115 into which web page information is retained.

Embodiments of the present invention include a concept-centric extraction system. The concept-centric extraction system may be implemented within the search server 112 or on a separate server, such as illustrated concept-centric extraction server 106. When web pages are obtained (e.g., via search query or web crawling mechanisms), the concept-centric extraction server 106 may be adapted to mine such provided web pages for structured information as described further herein.

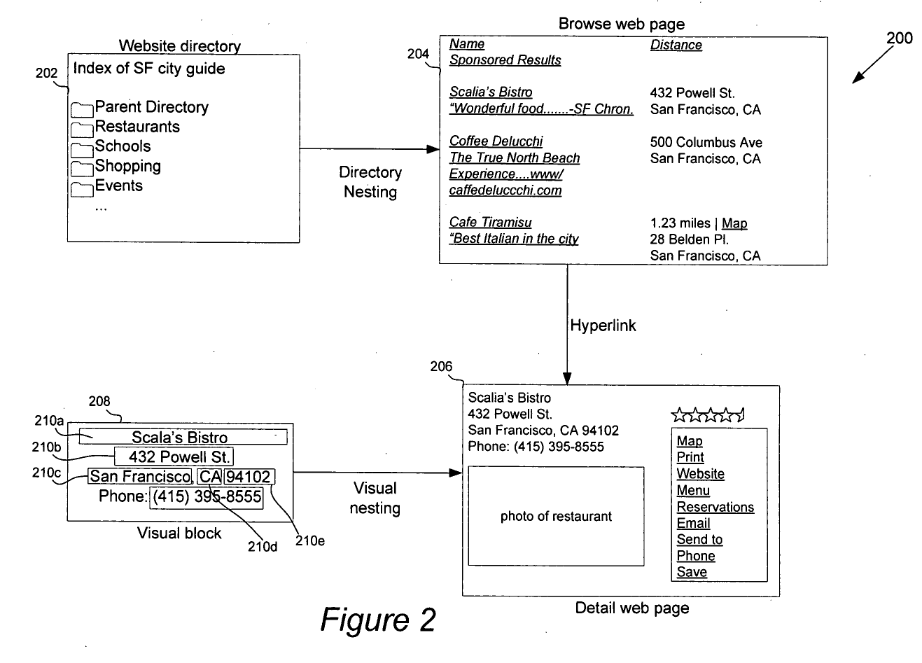

FIG. 2 is a diagrammatic representation of a typical extraction scenario. A web site typically contains individual web pages organized in a directory structure. Some web pages are dynamically generated from data in a database in response to queries, e.g., as input to a web form. Structurally, a web page may contain multiple constituent objects such as frames, tables, text fragments, and hyperlinks. As shown in FIG. 2, a web site may include a web site directory 202 having a plurality of web pages, for example, in different categories. In the illustrated example, a web page 204 from the restaurant directory of a San Francisco guide web site may be browsed by a user. This browsed web page 204 may also contain a number of hyperlinks, which the user may select so as to be presented with a detailed web page 206 for the selected hyper link. The detailed web page 204 may incorporate various structured information, such as a particular restaurant record 208 having the following a name attribute and value 210a, an address attribute with multiple components (including a street component 210b, a city component 210c, a state component, and a zip code component 210e), and a phone number attribute and value 210d.

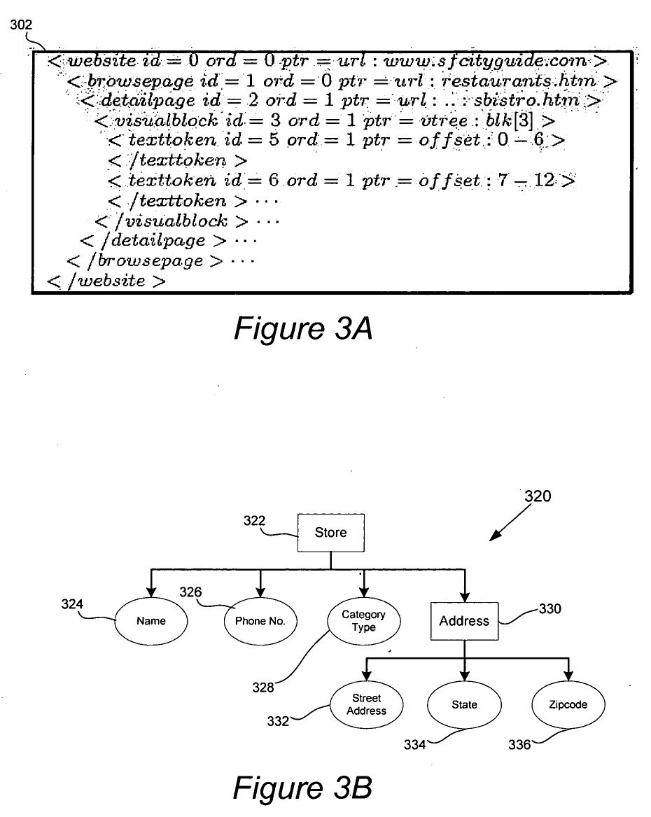

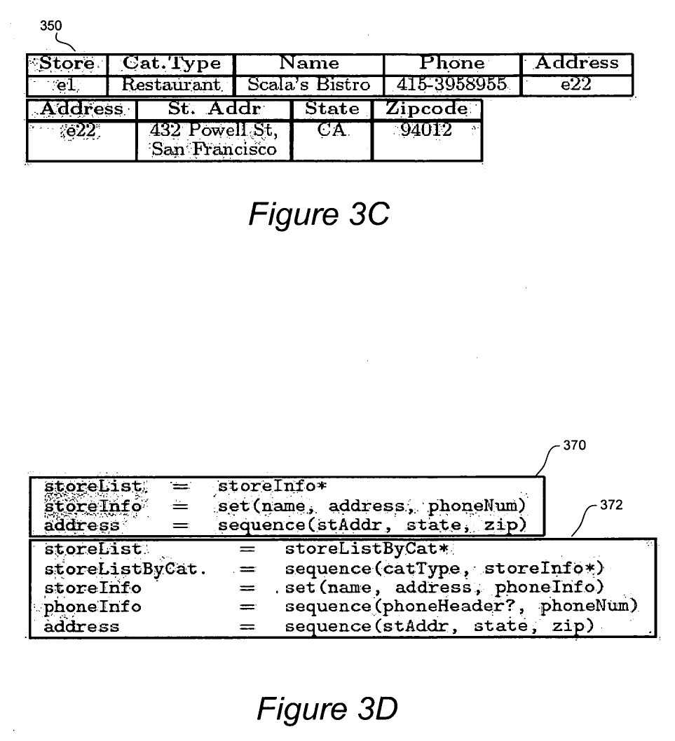

Given the complex nature of a web page, a web site can be represented by an input instantiation that accounts for relationships between objects (e.g., containment, precedence, hyperlinks) on a page and across related pages, and such input instantiation can serve as input to an extraction algorithm. For example, the input to extraction can be represented as a set of trees in which each node corresponds to a web object (referred to herein as the logical representation of the input) such that the tree instances include one or more structured data instances. In general, when the relationship between parent and child nodes in the tree is that of containment, the order of children may be very informative, e.g., in the case of HTML parse or visual trees. Thus, the logical representation (input trees) can be readily encoded as a set of XML documents with web objects corresponding to nodes and special attributes to indicate ordering (ord) and pointers (ptr) to the original physical objects. FIG. 3A shows an example logical representation 302 for the running example of FIG. 2.

Extraction generally includes obtaining structured data representing concepts of interest, which can be described using concept schemas. Since the task of extracting concepts from across multiple web sites is challenging, it is preferable to utilize domain knowledge in a concept-centric extraction approach. Even when such domain knowledge is only partial or uncertain, domain knowledge can narrow down extraction choices. Concepts of interest could be presented in many alternative ways on a given page. A specific example of domain knowledge includes rules that allow for building the desired concepts from the atomic objects that are identified on the page. This specific type of domain knowledge is referred to herein as presentation rulesets.

The concept schema is generally a hierarchical abstract representation of the desired data to be extracted. In a specific embodiment, the concept schema can be viewed as a labeled tree, where each node corresponds to a named concept with the leaf nodes corresponding to atomic concepts. It is noted that concept schema is not limited to a hierarchical or tree notion and can take any suitable form, such as an entity-relationship graph based specification. FIG. 3B shows an example of a concept schema 320 with atomic concepts represented as ellipses and the rest as rectangles. The root of the hierarchy is a named concept store 322 and it contains the named atomic concepts name 324, phone number 326, category 328, and the non-atomic concept address 330, which itself contains the named atomic concepts street address 332, state 334, and zip code 336. In this FIG. 3B, phone number 326 is a sub-concept of store 322. This scheme can be interpreted to mean “a store can have one or more phone numbers” and not “a store can have at most one phone number”. A structured output instance can be defined as an instance of this concept schema, in other words, an assignment of data values to each atomic concept in the hierarchy (multiple values and null values are permitted) and associations amongst them. For instance, the concept schema can specify how each piece of information relates to each other in a record list containing a hierarchical set of attribute and value pairs.

FIG. 3C shows an example representation of structured output records associated with the running example of FIG. 2. One goal of extraction can be to obtain structured output records conforming to the concept schema from the input data. As shown, the following information has been extracted for a particular store (e.g., identified by “e1”): a Category attribute having a value of “Restaurant”, a Name attribute having a value “Scala's Bistro”, a Phone attribute having a value “415-3958955”, and an Address attribute (e.g., identified by “e22”) having associated sub-concepts of Street Address having a value “432 Powell St, San Francisco”, a State attribute having a value “CA”, and a Zipcode attribute having a value “94012.”

The data corresponding to non-atomic concepts (in the input tree representation) can be presented in many ways, e.g., stores can be listed sequentially, they can be separated by (unknown) designated HTML tags, they can be arranged horizontally and vertically, they can be grouped by state (with the state name appearing before the list of stores), etc. In such cases, annotating input nodes (or segments) with atomic concepts may not be enough to obtain complete instances of the target concept schema since there might be ambiguity in the associations between different objects.

A presentation ruleset can bridge the gap between the raw input instances and the structured output instances by describing possible topological relationships (hierarchical and ordering relations) between nodes in the input that facilitate mapping of extracted atomic values to concepts in the target concept schema. The presentation ruleset can be specified as a set of context-free grammars with respect to the logical representation of the input (not the visual layout). An example of such a grammar is described in A. Arasu and H. Garcia-Molina, Extracting Structured Data from Web Pages, In SIGMOD, 2003, ACM, 2003, which article is incorporated by reference herein in its entirety. Note that some of the symbols in the grammars could be the names of concepts from the concept schema (or placeholder variables if the concept schema has yet to be learned).

Part of the information extraction process can then be to determine which grammar in the ruleset best matches the input data. For example, a set of rulesets can be specified as applicable to particular domains, particular sites, or particular pages. Alternatively, web content may not be associated with a particular set of rulesets, and, in this case it may then be determined whether the web content matches any known ruleset. The layout of concepts in a web page can correspond to the parse tree of a particular word accepted by one of the grammars in the ruleset.

A presentation group is a terminal or non-terminal symbol in the presentation ruleset. FIG. 3D shows two specific presentation rulesets 370 and 372 corresponding to our running example of FIG. 2. Each ruleset includes a plurality of presentation groups (e.g., the rows starting with storeList, storeInfo, address, storeListByCat, or phoneInfo). Presentation ruleset 370 specifies store records that each include a name, address, and phone, and each address includes a street address, state, and zip code. The presentation ruleset 372 specifies store records that are listed under particular categories. For example, restaurants could be listed and grouped by local area or food type. This presentation ruleset 372 for restaurants listed by category also specifies that each store record (e.g., that is listed under each category) could also include a name, address, and phone. In this ruleset, each phone record includes an optional phone header and a phone number, and each address record includes a street address, state, and zip code.

Although complete record lists are defined by the illustrated presentation groups of an illustrated rulesets, a presentation group may simply correspond to one or more specific records, a sub-set of a particular record, or a single attribute-value pair. That is, an actual input tree could include a restaurant list such that individual restaurants records include some or all of the attribute-value pairs as specified by the corresponding ruleset. For example, a restaurant ruleset could specify a restaurant record to include a name, address, phone, and website, while a specific input web page may include a list of restaurants with a first restaurant object that includes a name, address, phone, and a website and a second restaurant object a name, address, phone, but does not include a website.

To formalize the problem of annotating a tree in the logical input representation, an annotatable segment can first be defined as either an individual node or a contiguous sequence of ordered sibling nodes, e.g., text tokens (5-6) in FIG. 3A. That is, the nodes of an annotatable segment would have a same parent or, said in another way, be comprised of siblings that are contained by the same parent). This approach can induce various topological relations (e.g., contains, precedes) between a given pair of segments. Four mutually exclusive annotation types, by way of example, may be considered: “exact”, “contains”, “part-of” and “not-relevant” to capture how an annotatable segment relates to a presentation group. Possible annotations can be assessed to determine whether they meet the requirements of one or more properties. Specifically, a segment s can be defined as “not-relevant” to a presentation group c if there is no segment that (a) is an exact match for c and (b) contains s, is equal to s, or is part-of s. Similarly, s “contains” (resp. is part-of) a match for a presentation group c only if there exists at least one segment s′ that is exact match of c and that is contained in (resp. overlaps with) s.

Let e be a tree resulting from the logical representation of input data; C_{P} denotes the set of presentation groups that may be applicable to the particular input data; and Sₑ denotes the set of all annotatable segments in e, and T={exact, contains, part-of, not-relevant}. A fine-grained annotation can be defined as an indicator function y(s, c, t) that specifies if a particular segment sεSₑ is a t-type match of the presentation group cεC_{P}, e.g., a segment s₁ that matches a zip code ruleset can be expressed as y(s₁, zip, exact)=1. Similarly, a segment s₁ that matches a store record list can be expressed as y(s₁, storelist, exact)=1. An annotation query, on the other hand, can be defined as a request for an annotation and can be specified by the tuple (s, c, t) itself, e.g., the tuple (s₁, zip, exact) is a query on whether segment s₁ matches a zip code.

A complete annotation y(e) of the tree e can then be defined as a segmentation of e into annotatable segments and relating each of these segments with a particular presentation group. Thus, the annotation y(e) of tree e can be defined as the set of binary random variables {y(s, c, t) (s, c, t)εSₑ×C_{P}×T}. Since the structure of e imposes constraints on the indicators y(s, c, t), the set of possible annotations for an input instance Y(e, C_{P}) is constrained both by the input data and the available presentation groups.

Given an input instance E={e1, e2,} (the trees in the logical input representation), a target concept schema C_{D}, a particular presentation ruleset R_{CP}, and various forms of other domain knowledge DK, a set of structured data instances O={o1, o2, . . . ,} conforming to the target concept schema C_{D} may be obtained. This task may include two sub-tasks:
Annotating the trees in the input instance in terms of the presentation groups, e.g., obtaining y(e)={y(s, c, t)}ε(s, c, t)εSe×Cp×T for some eεE using the domain knowledge DK and a particular presentation ruleset R_{CP}. The eεE that is annotated corresponds to the logical representation that is most useful for extracting information from the web page(s) of interest.
Extracting structured data instances from the annotated eεE using the mapping between the presentation groups in C_{P} and the concepts in the target concept schema C_{D}.

In certain embodiments, it may be assumed that the set of concepts C_{D} of the concept schema are known with a deterministic mapping between C_{P} and C_{D}. Thus, the first sub-problem will initially be described and, unless otherwise mentioned, the terms concept and presentation group are used interchangeably.

Large scale and high precision web extraction places heavy demands on the architecture. These demands include the need for batch processing for efficiency, incorporation of all available knowledge about a domain, adaptability to new domains, and minimal human intervention.

These issues may be addressed by breaking up the extraction process into smaller tasks and by designing operators to handle each task. By treating these operators as black boxes, they can be swapped in and out, reconfigured, and shared between related domains.

Operators can also be used to facilitate encapsulating domain knowledge for the following reasons. First, many varied forms of domain knowledge are available. Second, presentational regularities (with varying levels of reliability) within a web page can serve as local cues on how to perform extraction. Third, complex preconditions affect when and how domain knowledge can be used (for example, a domain-specific annotator that can identify a store concept may first require knowledge of the phone and zip code concepts present in the page). All of these issues would make the traditional machine learning paradigm of a feature/label representation both impractical and awkward if a single joint inference algorithm were to be used.

Thus, multiple operators can be used to assimilate the available predictive cues. The input to each operator can be defined as a data instance (in its logical representation), various fine-grained annotations of this data instance, and a set of annotation queries (i.e., requests for annotation as described further herein). The operator can then return responses (and associated measures of confidence) to the annotation queries. For example, an operator might take existing annotations on segments s₁ and s_{2,}, which are associated with zip code and state concepts, and provide a response on whether segment s₃ is an instantiation of address. This modular decomposition allows black-box labelers to be readily incorporated, rapid domain customization by efficient reuse of existing software, and also greatly reduces computational costs via batch processing.

This modularity also enables the possibility for effective planning of the extraction workflow. Planning can generally involve identifying the operator pool, satisfying operator precedence constraints, and selecting operators based on their expected reliability and computational cost.

Each operator can, therefore, be characterized along four dimensions: (a) preconditions on input annotations, (b) output specification (c) range of applicability (local to instance vs. domain-wide), and (d) customizability with respect to concepts. When discussing the customizability of an operator, the term “rigid” is used herein to refer to a concept-specific operator such as a regular expression or a dictionary that does not support learnability, and the term “adaptive” is used herein to refer to an operator whose output is customizable such as a conditional random field based or CRF-based named entity recognizer, Hidden Markov Model-based or HMM-based list detector, etc. This customizability aspect also allows one to incorporate domain knowledge that does not directly yield concept annotations (such as informative features/kernels), and soft concept constraints. Examples of an adaptive operator, which combines existing annotations and page-specific formatting to boost accuracy through a technique referred to herein as “local learning”, are described further herein.

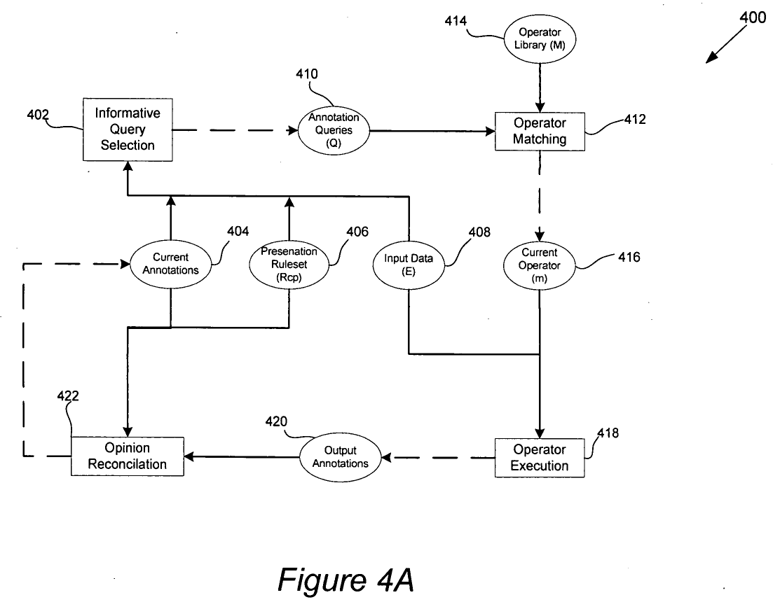

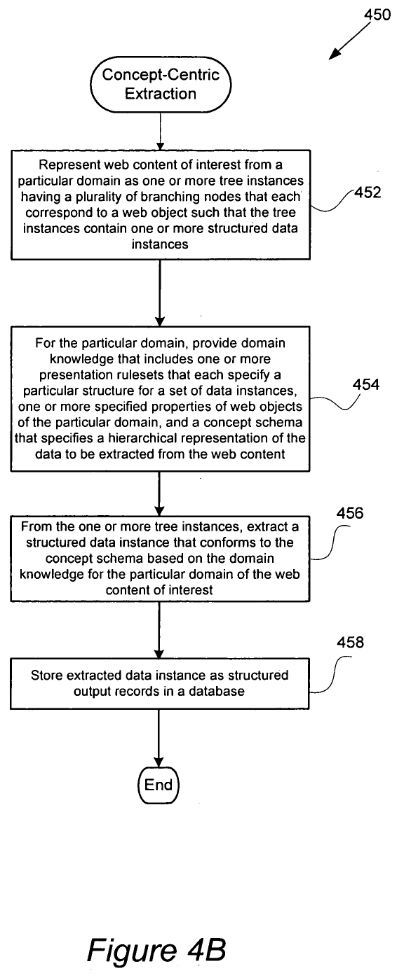

FIG. 4A depicts a basic architecture of a concept-centric extraction system 400 in accordance with one embodiment of the present invention. Given an input data corpus 408, presentation ruleset 406, and a library of operators 414 (both rigid and adaptive), the goal is to identify and execute an efficient workflow using selected operators to annotate all or some of the input data. The illustrated extraction approach of FIG. 4A is a process that iteratively identifies annotation queries Q (410) that are expected to be highly informative given the topology of the input instances 408, the presentation ruleset 406, and the known or current annotations 404 (e.g., annotation queries identified by informative query selection module 402). Then, the most appropriate operator m (416) is selected from the operator library M (414) based on the input preconditions and the selected operator's expected ability to answer the annotation queries Q (410). The chosen operator m (416) is then executed (e.g., by operator execution module 418), and the resulting output annotations 420 can be fed into an opinion reconciliation module 422. Since different operators may have different opinions about the same segment, it is up to the reconciliation module 422 to resolve these conflicts and update the annotations. This process may be repeated until the output annotations 420 are complete or there is no new module operator of providing additional or better predictions.

In FIG. 4A, the modules of informative query selection 402, operator matching 412, and opinion reconciliation 422 can generally correspond to tasks involving active inference (to select informative annotation queries), workflow planning, and opinion reconciliation for structured output spaces. These tasks may be accomplished in any suitable manner in terms of the statistical dependencies between the output variables y(s, c, t) encoded in the presentation ruleset. For example, a simple heuristic solution to these tasks may be implemented. Example embodiments are further described herein. The flexibility of combining rigid domain specific operators with adaptive local learning operators as described further herein can yield huge benefits.

A specific instantiation of the above architecture that employs topological additive/deletion rules, precedence information, and operator weights for determining the informative annotation queries and for reconciling conflicting annotations, as well as a local learning scheme, is described further herein. However, a concept-centric extraction procedure will first be briefly described in more broad terms. FIG. 4B is a high level flow chart illustrating a concept-centric procedure 450 for extracting information from web content in accordance with one embodiment of the present invention. This procedure flow merely seeks to summarize some of features of a concept-centric extraction process and not limit concept-centric extraction embodiments to a specific workflow. Various steps of this general extraction process may be iteratively performed in any suitable order, using any suitable operators, so as to incorporate local learning as further described below.

As shown in FIG. 4B, web content of interest from a particular domain may be initially represented as one or more tree instances having a plurality of branching nodes that each correspond to a web object such that the tree instances contain one or more structured data instances in operation 452. For example, the web content may be represented with a document object model (DOM) tree representation. A suitable application for obtaining DOM tree representations from web content includes the Xerces DOMParser, and JTidy page. For the particular domain, domain knowledge may be provide in operation 454, and this domain knowledge may include one or more presentation rulesets that each specify a particular structure for a set of data instances, one or more specified properties of web objects of the particular domain, and a concept schema that specifies a hierarchical representation of the data to be extracted from the web content. From the one or more tree instances, a structured data instance that conforms to the concept schema may then be extracted based on the domain knowledge for the particular domain of the web content of interest in operation 456. The extracted data instance may be stored as structured output records in a database in operation 458 for various purposes and uses (e.g., database queries).

One of the main problems that arises when domain knowledge is provided by a human is that this knowledge is incomplete and sometimes incorrect. For example, consider the following regular expression (1\s)?\(d\d\d)\s\d\d\d\s?\−\?\d\d\d\d. Such regular expression can recognize phone numbers of the form 1 (800) 123-456 and (800) 456-1234. However, this expression will not recognize 1 (800) FLOWERS, and will incorrectly label (123) 456-789982823838 as a phone number. On one hand, a more complicated regular expression to handle these cases could be produced. A more complex expression will still not guarantee perfect accuracy and may introduce bugs. On the other hand, this simple regular expression will work most of the time, so the simple regular expression can be used in a local learning approach to make the extraction algorithm robust to errors in domain knowledge. Certain embodiments of the present invention utilize the later approach. The intuition behind this approach is that phone numbers in different records on the same page are likely to be formatted similarly, e.g., having an XPath/divib. Features that have a page or web-site specific scope, e.g., html formatting, are referred to herein as “local features.” These local features can be learned from the labels produced by high-precision annotators (such as this regular expression). Based on this concept, a local parametric model can be learned based on features of labeled nodes and a consensus model, which reconciles any disagreements between the high-precision annotator and the local parametric model.

In a specific embodiment, local learning may generally include obtaining annotations for some segments and then learning a model based on features associated with the annotated segments and whether such learned model will provide additional annotations or clean up noisy annotations. In a formalized local learning approach, let S_{cand} be the set of segments of the logical input tree which can be annotated. For example, S_{cand} can be the collection of all sets of consecutive nodes with the same parent. Let z(s) be a random variable representing the label of a segment sεS_{cand}. A domain-specific concept annotator m may only provide labels for a subset S_{lab}⊂S_{cand} of segments by assigning a probability distribution p^{m}(z(s)) for each sεS_{lab}. Let x(s) be a feature vector for segment s (computed from the local features associated with s). In this example, the goal may be to compute the probability distributions p_{Ø}(z(s)|x(s)) and ~p(z(s)); p_{Ø}(z(s)|x(s)) is a local parametric model that predicts labels given local features, and ~p(z(s)) is the consensus model that reconciles disagreements between p^{m}(z(s)) and p_{Ø}(z(s)). Since, in general, a goal can be to have ~p be “similar” to both p^{m} and p_{Ø}, the quality of ~p can be measured using the loss function:

$$L ( {}^{\sim} p ) = α {\sum }_{z ( s ) \vert s ∈ {S}_{lab}} d ( {}^{\sim} p ( z ) , {p}^{m} ( 𝓏 ) ) + ( 1 - α ) {\sum }_{𝓏 ( s ) \backslash s ∈ {S}_{cand}} d ( {}^{\sim} p ( z ) , {p}_{φ} ( 𝓏 \vert x ) )$$

where αε[0, 1] measures our confidence in the domain knowledge and d(•,•) is a dissimilarity measure between two probability distributions.

When d(•,•) is convex in the first argument (e.g. KL-divergence or square of the L2 distance), the above formulation allows a straightforward iterative EM-like solution involving alternate optimization of the parameters Ø and the distribution ~p(z). In particular, when d(•,•) is chosen to be KL-divergence, closed form updates can be obtained for ~p(z) and the estimation of local parameters essentially reduces to a likelihood maximization. Hence, this iterative approach can be used with any well-behaved parametric model (e.g., logistic regression, naive Bayes, mixture distributions) that supports efficient parameter estimation via likelihood maximization.

An instantiation of the above local learning approach requires choosing the relative importance factor α and the form of the parametric model p_{Ø}(•). The choice of α can be determined by subjective belief in the expected precision of the domain module m. When the predictions p^{m}(z) do not contain any noise, one could choose α=1, which is equivalent to fitting the local parametric model to p^{m}(z). The choice of the parametric model may be determined by a number of factors. One factor may include the skew in the labeling distribution of the domain module m. For example, if m identifies only positive examples, then a generative mixture model may be more appropriate than a discriminative model (e.g., support vector machines, logistic regression). The choice of a parametric model can also be guided by the nature of the available local features since not all models handle features that are binary, directional, real-valued, etc.

Specific embodiments of a concept-centric system that implements adaptive local learning will now be described. In general, this system can be used to identify concepts that the high precision annotators have missed or filter out noisy annotations that can be detected via local features. The above approach can also be extended to other scenarios with a complex output space such as partitioning a segment known to be a concept list into individual concepts, but these details are omitted so as not to obscure the main features of such a system.

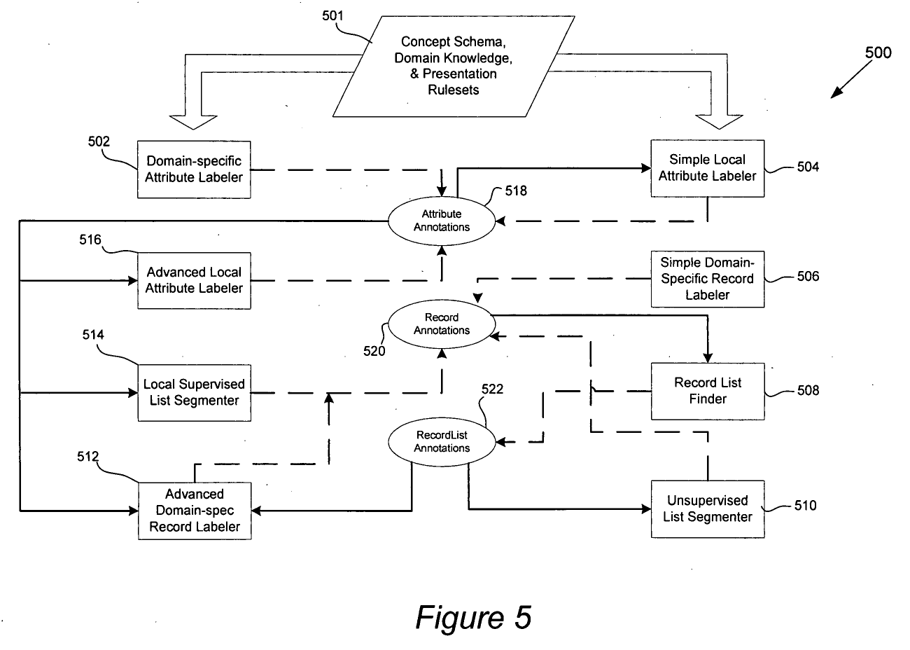

FIG. 5 is a representative diagram of an example workflow 500 for list extraction, which utilizes adaptive local learning, in accordance with a specific implementation of the present invention. To demonstrate the benefits of a modular approach as well as adaptive local learning, an exemplary unsupervised list extraction technique is augmented with specific local learning modules to obtain high quality results.

The illustrated workflow 500 utilizes a plurality of different annotation modules or operators (e.g., modules 502, 504, 506, 508, 510, 512, 514, and 516) as described further below. As shown, the annotation modules can be provided with concept schema, presentation rulesets, and domain information (501).

Domain knowledge can provide additional input to guide the extraction process. A few kinds of domain knowledge that have been found to be important in practice are described herein. Domain knowledge can be applicable to particular domains, particular sites, or particular pages.

Concept labelers are generally a common form of domain knowledge that determine whether a particular web object (e.g., DOM or document object model node) contains (or corresponds exactly to) a concept (e.g., an address). Atomic type labelers are a special case; they identify an atomic concept (e.g., a state name) in a piece of text. Approximate matching to lexicons of positive examples from feeds (or earlier extractions/human feedback) also can form an important class of concept labelers. Positive examples can be used to train labelers even in the absence of matches using features as proxies for examples.

Predictive features and similarity functions specified by users can often be very helpful even if it is not known how to use these features in the context of the prediction task. For example, a user may specify that the keyword “Phone” or visual gaps (this is an example of information about the target audience of the web page) can be useful. These predictive features can then be used to extrapolate from the predictions of low recall concept labelers. In certain cases, instead of explicit features, it might be possible to specify similarity functions associated with certain concepts, e.g., DOM tree edit distance.

Soft concept constraints can be viewed as the analogue of database integrity constraints and help identify which sub-concepts belong together. Examples include multiplicity constraints: “there are usually 2-3 phone numbers”, “a fax number is optional, but present 70% of the time”, and general consistency constraints: the zip code in a record must belong to the state. These constraints come with a violation cost that can be thought of as an indicator of the likelihood that a particular web object represents a given named concept.

Concept schema and presentation rulesets may be provided in any suitable manner so as to enable adaptive local learning. Most category-specific extraction scenarios involve the notion of a category-specific entity (e.g., business store, publication) with multiple atomic attributes, which corresponds to a flat concept schema consisting of a named concept associated with an entity-record (R) and multiple atomic sub-concepts {Al, . . . , Ar} associated with various attributes. A common presentation format for this type of information (e.g., store-listings, bibliographies) can include multiple contiguous entity-records, each of which contains instantiations of all the attributes. There may be a direct mapping between the target concept schema and the groups in the presentation ruleset. An auxiliary presentation group corresponding to a record-list (L) may be used. The record-list (L) can be defined as a maximal contiguous sequence having only entity-records along with the following grammar rules: (a) L=R*, (b) R=set(Al, . . . , Ar), with flexible ordering of attributes and non-mandatory attributes preceded by the optional operator.

For example, a subset of nodes may be initially annotated, for example, by a high precision annotator (e.g., regular expressions) so as to label, for example, atomic values. Annotatable segments may then be assessed as being more or less likely to correspond to a particular presentation group in the specified rulesets. For instance, the annotated atomic concepts may be analyzed as being arranged in a particular way that corresponds more close to the particular arrangement of corresponding concepts in a particular ruleset. Using the illustrated ruleset examples of FIG. 3D, if an annotated category contains a number of atomic address and phone number values, it is more likely that the annotatable segments correspond to the ruleset 372, which specifies restaurants being listed by category. This assessment may have associated scores for each ruleset so as to determine which ruleset has the highest score with respect to the annotatable segments. The most likely corresponding ruleset may then be used to annotate the rest of the annotatable segments by specifying a likely hierarchy of record concepts and lists. The selected ruleset will facilitate further annotation since the expected hierarchy of the records or lists is now known.

In the illustrated embodiment, the workflow 500 may commence with execution of a domain-specific attribute labeler module 502 based on the provided domain knowledge. Domain knowledge can be specified for an entire domain (e.g., applicable to all pages and sites belonging to such domain), a particular site, or particular pages of a particular site. In a typical extraction scenario involving the specific case of record lists, the concept-centric extraction system (or specific workflow) has access to domain knowledge that takes one or more of the followings forms: (a) domain-specific atomic attribute labelers that act on single text nodes (e.g., regular expressions or lexicons), (b) domain-specific record labelers that can determine if a segment is an exact match or contains an entity record given the attribute annotations (e.g., rule-based classifiers), (c) generic local features and similarity functions (n-grams/edit distance over HTML/visual/text patterns), (d) advanced features predictive of attributes that require record annotations (e.g., positioning within a record), (e) advanced local features and similarity functions predictive of records that require attribute annotations (e.g., edit distance on attribute annotations patterns). For example, the domain knowledge may correlate local features or feature properties (e.g., edit distance) with the likelihood that the associated node matches a particular concept and/or atomic value.

Using the available local features of the input instance and the initial annotations from the rigid domain-specific labelers, one can now construct local adaptive concept annotators for records and attributes (e.g., as described with respect to FIG. 4A). Since the domain-specific annotations are often very skewed (e.g., only positive examples in case of most attributes) and the features are mostly binary, a semi-supervised clustering technique may be performed over a mixture of two von-Mises Fisher distributions (e.g., using cosine similarity) to separate out the positive matches from the rest. Similarly, an adaptive concept-list segmenter can be trained for partitioning record-lists using existing record annotations on the candidate segmentations discovered by an unsupervised list segmenter, such as the Alvarez algorithm (further described in the article M. Alvarez, A. Pan, J. Raposo, F. Bellas, and F. Cacheda, “Extracting Lists of Data Records from Semi-structured Web Pages”, Data Knowl. Engg., 2008, which article is incorporated herein by reference in its entirety), and local features associated with records. Since only record boundaries need to be identified, this can be accomplished via a conditional random field model with two classes (boundary/not). The relative importance weight a can be determined by a grid search for each model though α=1 provides reasonable performance in most cases.

The workflow may include any suitable unsupervised list extraction modules, such as a record list finder module 508 and an unsupervised list segmenter 510. In recent years, a number of unsupervised list extraction techniques based on local regularity assumptions (e.g., visual gaps, periodicity) have been proposed and shown to have limited success. To illustrate an adaptive local learning extraction methodology, the Alvarez algorithm may be considered and may be readily adapted to a tree-based input representation even though it was proposed for HTML pages.

A modified Alvarez algorithm can be based on the assumption that entity-records correspond to structurally similar contiguous sequences of sibling sub-trees using a general similarity measure and that each record consists of attributes that share the same XPath in the DOM tree. The latter assumption is used to identify the record-list region by having pairs of text nodes with a common XPath to vote on their least common ancestor node and selecting the one(s) with the maximum vote total. Each node identified as a record-list region is then partitioned into records by first clustering the immediate child nodes with an appropriate edit-distance based measure, then encoding the child node sequence using the cluster identifiers, and finally generating/evaluating candidate segmentations based on heuristics (e.g., common prefix/suffix for each record).

One can decompose this method into two extraction modules: (a) a generic concept list finder that finds a list region given instantiations of the elements (in this case, text nodes that are assumed to contain attribute values and approximate the records), and (b) an unsupervised list segmenter that segments a concept list (in this case, record-list) into the constituent concepts (i.e., records) by encoding the list as a string and using a generic string kernel as the concept similarity measure

To set up a workflow for list extraction in general, the process of determining and executing a workflow based on various extraction modules may be considered. One or more extraction modules may be selected based on which modules are capable of providing a prediction on the maximum number of queries in Q and (c) using relative importance weights estimated via grid search and/or user-specified precedence rules so long as the presentation ruleset is not violated.

To address the informative query selection problem, the query pool Q may be initialized with atomic concept queries that are likely to receive high precision responses based on domain knowledge. For example, queries for specific regular expressions can be initially selected as a query pool. Thus, in the case of record-list extraction, the seed query set is given by Q⁽⁰⁾={(s, c, t)} where cε{Aₗ, . . . , Aᵣ}, tε{exact, contains}, and s is chosen to be only singleton node segments so as to limit the computation. It may then be determined which operators are capable of addressing the queries of the pool as further described herein to obtain annotations. These output annotations are then reconciled to obtain current annotations. The query set Q can then be updated using topological addition/deletion rules that specify the annotation queries {(s′, c′, t′)} that are likely to be informative (e.g., have a high degree of uncertainty and potential to yield positive annotations) as well as those that cease to be informative (e.g., known to be true or false) respectively given knowledge of some output variable y(s, c, t) as produced by the iterative annotation process. These rules could be specific to particular concepts or based only on the topology of the input data instance and the presentation ruleset. In the case of record-list extraction, when a segment s is annotated with an attribute Ai as an exact match or as containing such attribute, a likely next query to be added to the query pool is a query for a potential instantiation of entity-record R within a parent of such segment s, whereas any sub-segment s′ of s may clearly not be likely to be a match of R and can be removed from Q.

For the record-list extraction problem, deletions arising from the presentation constraints can be considered, as well as the additive exploration rules in Table 1 below, with cseq(s) denoting the set of all contiguous subsequences of immediate child nodes of s. For example, the first row of Table 1 specifies that a query for entity-record R should be added for the parents of a segment that is annotated exact or contains with respect to an entity-attribute, Aₗ. One or more added queries (labeled as “Informative Queries”) may be specified for each type of annotated segment (labeled as “Positive Annotation”). The exploration rules may also specify queries to be deleted from the query pool. Ideally, the exploration rules are set up so as to specify queries for which the answer is unknown or uncertain and valuable. The exploration rules can ensure that once a segment has been identified as a match for an attribute (or record), its ancestors are successively considered until the record (or record-list) is identified. Similarly, once a record-list has been identified, its sub-sequences can be evaluated for being sub-lists and records until the records are found, which can then be further refined to obtain attribute matches. The recursive drilling down (e.g., y(s,R, contains)≈1→ADD (s′,R, exact/contains), s′εcseq(s)) can be useful in case of nested records and/or attributes.

TABLE 1
Example Exploration Rules for List Extraction

| Positive Annotation | Informative Queries |
|---|---|
| y(s, Ai, exact/contains) | (s′, R, exact/contains), s′ = parent(s) |
| y(s, R, exact/contains) | (s′, L, exact), s′ = parent(s) |
| y(s, L, exact) | (s′, R, exact/contains), |
| | s′ ∈ cseq(s) |
| y(s, R, contains) | (s′, R, exact/contains), |
| | s′ ∈ cseq(s) |
| y(s, R, exact) | (s′, A, contains), |
| | s′ ∈ cseq(s) |
| y(s, Ai, contains) | (s′, A, exact/contains), |
| | s′ ∈ cseq(s) |

The above table is set up to provide informative queries based on rules for deleting or adding queries for particular related segments of annotated segments. However, the rules may be based on concepts, hierarchy of the annotated input instances, or some quantifiable properties, such as the entropy of the distribution with respect to the annotated input instances.

Given the above exploration rules and the different extraction operators, one can now obtain a suitable extraction plan for the given input data. Specific operators or extraction operators can be selected based on predefined preconditions and outputs for each candidate operators. For example, it may be determined whether an operator has its preconditions for annotations met with respect to the already annotated nodes of the input instance and whether the expected output from such operator is the type of output that is needed by the current queries (e.g., as triggered by the exploration rules). The candidate operators may then be scored based on how many queries they can handle, and the candidate operator with the highest score may then be selected and executed. For example, if most of the queries pertain to phone numbers and a minority of queries pertains to store records, an operator that extracts phone numbers may be selected. In another example, if a first operator requires address annotations and a second operator requires email annotations and the current annotations only include addresses, then the first operator will be selected.

Since different operators may annotate a same node differently, an opinion reconciliation module may be configured to determine which annotation to keep. In a simple implementation, a precedence list may specify which operators annotate better and the annotation that is produced by the highest ranked operator is retained. In another embodiment, a weight based approach may be used. For example, each annotation result may be associated with a known or a learned weight (e.g., confidence value). A combination of these weights (e.g., weighted average) may then be determined. The final annotation value is then based on the determined combination weight value.

FIG. 5 shows a typical workflow comprising of domain specific labelers (e.g., 502, 506, and 512), unsupervised list extraction modules from Alvarez et al. (e.g., 508 and 510), and adaptive learning modules (e.g., 504, 514, and 512), and the numbering of the boxes (e.g., 502˜516) denotes an example sequential order. First, the domain specific attribute labelers (502) may be invoked followed by an adaptive local attribute labeler (504) based on generic local features to get improved coverage. Given the attribute annotations, the exploration rules can lead to new record queries, which can be addressed using a crude domain-specific record labeler (506), further leading to record-list queries, which are resolved using a list finder, such as an Alvarez list finder, (508), and so on until all the record and attribute annotations are obtained.

FIG. 5 highlights the data-driven nature of this local learning and concept-centric extraction approach, which tries to make the best possible use of the available operators using only the exploration rules. For example, the adaptive local attribute labeler (506) may be chosen to be invoked in step 2 due to the low recall of the domain-specific attribute labeler (502) and may be skipped if the coverage was better since there would not be many attribute annotation queries in Q. Similarly, the Alvarez list finder (508) is most effective when there are some annotations on the elements of the list (records) and may hence, be chosen to be invoked as a fourth step instead of up front in a 3^{rd} step. The remarkable thing about this modular approach is the flexibility it affords in combining not only domain-level and instance-level information, but also other existing algorithms as indicated by the many different operator types (e.g., 502˜516) in the example.

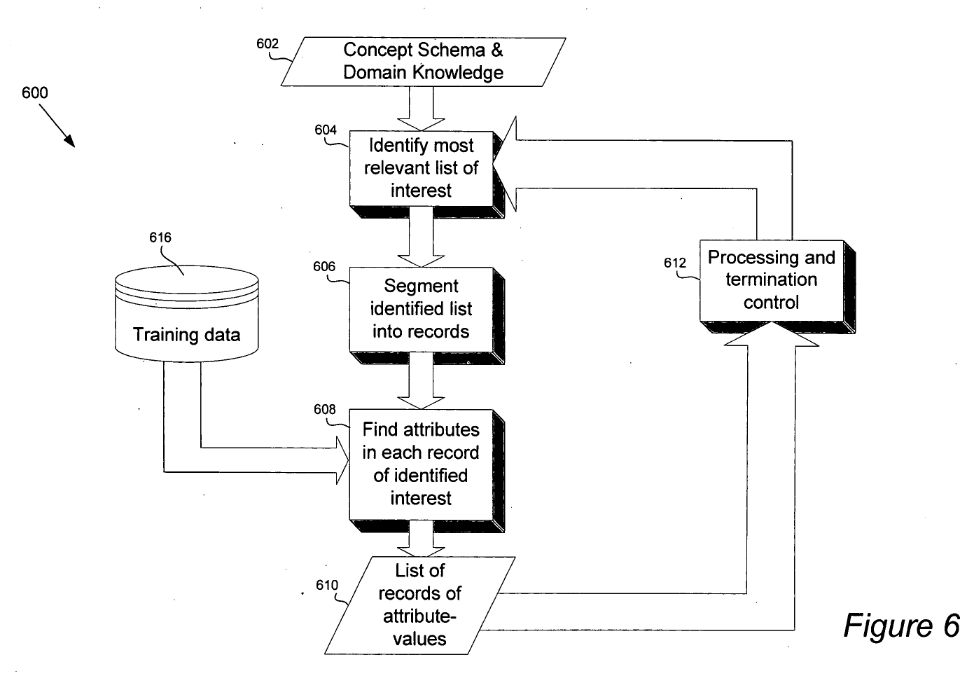

FIG. 6 is a diagrammatic representation of a concept-centric list extraction system 600 in accordance with a specific implementation of the present invention. In general, this concept-centric list extraction system 600 operates to analyze portions of a web page to find the most relevant list of interest, along with identifying the records and attribute-value pairs within such most relevant list of interest.

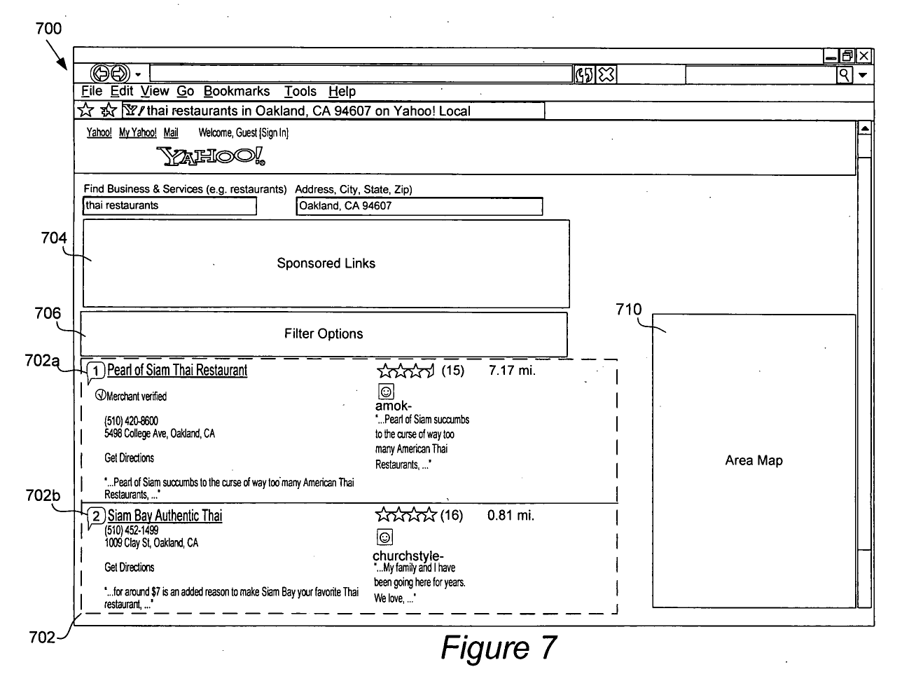

FIG. 7 illustrates a typical web page 700 that pertains to a restaurant domain. As shown, search results are displayed after a user has entered search criteria for “that restaurants” within the “Oakland, Calif. 94607” area. In this example, the list of interest corresponds a list of restaurants and their associated records and attributes or attribute-value pairs. Although different areas of the web page may contain any number of lists, the most relevant list area is restaurant results list 702. Although this restaurant list is visually apparent as the most relevant list of interest to a user, automatically identifying such relevant list of interest within the web page 700 is not trivial. For example, the filter options area 706 may contain other types of lists in the form of selectable options, while the sponsored links area 704 may contain a restaurant list in the form of URL (universal resource locator) links. The web page may also contain noise or non-list web portions, such as area map 710, etc. Additionally, even when the most relevant list is identified, the records and attributes of such identified list may not be easily extracted. For example, the identified list may contain records for each restaurant with inconsistent attributes and formatting. For example, the first record 702a includes a “merchant verified” attribute, while the second record 702b does not contain such attribute.

In light of these challenges, a concept-centric list extraction system has been developed to find various types of lists of interest, which is independent of the particular formatting that is used by the particular web page. Referring back to the example of FIG. 6, the system 600 may be initially provided with concept schema and domain knowledge 602 for a particular type of list of interest. For the particular type of list of interest, the concept schema may specify a record and all of its possible attributes. For example, concept schema for a restaurant type list may specify a record as containing the following attributes: restaurant name, address, phone number, fax number, email, web page, map link, rating, price, category, reviews, etc. The domain knowledge may specify particular formats for the domain specific attributes. Possible values for a phone number attribute may be specified as having a particular format, such as “(nnn)nnn-nnnn” or “nnn-nnnn”, where each “n” corresponds to an integer between 0 and 9. In another example, a list of state and/or city attribute values may be provided.

The domain knowledge may also include scoring functions for determining whether a web portion corresponds to a particular presentation group, e.g., attribute-value, record, or list of interest in case of record-list extraction. In a simple function example for determining whether a web portion corresponds to a store type list or record, a web portion is given a score of 1 if such web portion contains a zip code and score of 0 if such web portion does not contain a zip code.

The concept schema and domain knowledge may be utilized to find or identify the most relevant list of interest in operation 604, break down the identified list into records 606, and identify the attribute-values in such records in operation 608 so as to generate a list (610) of records having one or more attribute-values. Although these operations are illustrated sequentially, these operations may be performed in any suitable order, any operation may be repeated, and any given operation may be partially performed before moving to a subsequent operation. For example, particular web portions of the web page may be analyzed to locate a most relevant (for now) list in operation 604 and then such identified list may be then be broken into records in operation 606. The list identification process 604 may then be applied to another set of web portions to identify a new relevant list that is then segmented into records in operation 606. In one specific embodiment, the concept-centric list extraction system 600 includes a process and termination control operation 612 for determining whether to repeat one or more list, record, or attribute-values identification operations.

Training data 616 may also be provided to the concept-centric list extraction system 600. This training data may provide example attribute-values for particular web portions. For example, the training data may specify that the “95054” within the web portion “Sunnyvale, Calif. 95054” is a zip code attribute-value. Any suitable number and type of training data may be utilized.

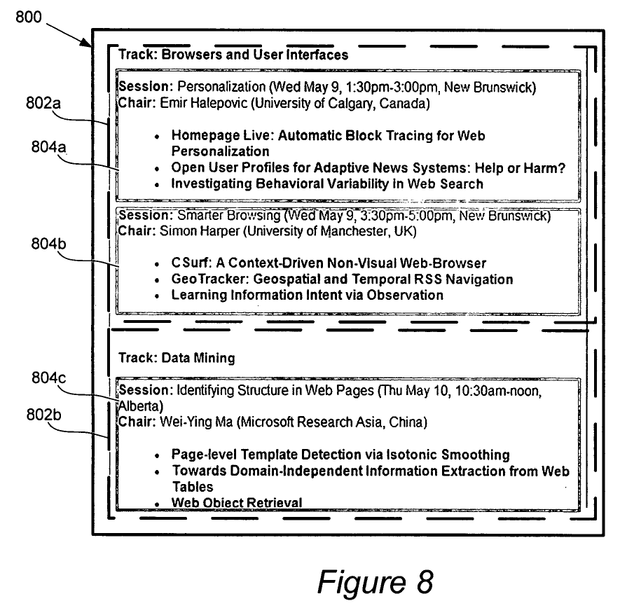

The concept-centric list extraction system 600 may perform such list, record, and attribute-values extraction on a web page that contains nested or non-nested lists. Thus, it may be useful to describe nested vs. non-nested lists prior to describing specific embodiments for implementing an concept-centric list extraction system. While FIG. 7 illustrated an example of a non-nested list of restaurant records (e.g., restaurant list 702), FIG. 8 illustrates an example of a nested list 800 for a conference. As shown, the nested list can be conceptualized as a plurality of records (e.g., 802a and 802b) that each correspond to a particular “Track”. Each track is directed towards a particular conference talk category. For example, a first record 802a pertains to “Browsers and User Interfaces”, while a second record 802b pertains to “Data Mining.”

While each record in a non-nested list generally only includes attribute-value pairs, a record in a nested list structure can include deeper lists. In the illustrated example, each track type record includes a deeper list of records that each pertain to a particular conference session of the associated conference session. As shown, track record 802a includes a list of records 802a and 802b that correspond to a session on “Personalization (Wed May 9, 1:30 pm˜3:00 pm, New Brunswick)” and a session on “Smarter Browsing (Wed May 9, 3:30 pm˜5:00 pm. New Brunswick)”, respectively. Although each session record of a particular track record includes attribute-value pairs (e.g., session title and session chair), each session record also includes a further nested list of papers. Each nested paper record may be also associated with one or more attribute-value pairs (e.g., title, author, date, etc.) and further nested lists. In summary, here each record of a list may include one or more attribute-value pairs and/or one or more nested lists along with shared attribute.

Although only the title of each paper record is shown, each paper record may also be associated with further information (e.g., author, date, publication source, etc.) that is viewable when a user rolls their mouse (e.g., or other input device) over the particular paper record. That is, the attribute-value pairs of a record may be statically or dynamically viewable by user of such web page.

Example embodiments of a concept-centric list extraction system will now be described in relation to non-nested lists. In these implementations, the web page is represented in the form of a document object model (DOM) tree. Any suitable software tool may be utilized to convert a web page to a DOM tree representation. Examples include the JTidy java package and Xerces DOM parser.

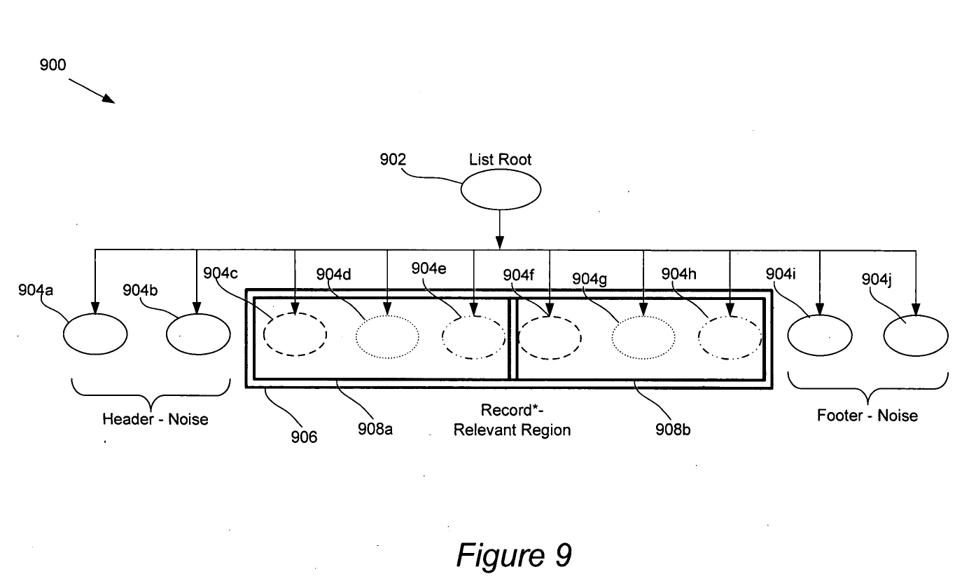

FIG. 9 is a diagrammatic representation of a DOM tree portion 900 that corresponds to a list from a web page. This DOM tree 900 includes a list root node 902 and child nodes 904a through 904j. Generally, some of the child nodes will tend to correspond to attribute-values of particular records. The child nodes are typically ordered so that attribute-values of each record are contiguous and the records are contiguous to each other. The child nodes at the beginning and end of the sequence will tend to be noise and not part of a record. As shown, child nodes 904a and 904b correspond to header noise, while child nodes 904i and 904j correspond to footer noise. In contrast, the remaining nodes 904c through 904h correspond to one or more records 906 of the list.

The attribute-values of a particular record can span one or more nodes. Additionally, each instance of a record may include some common attributes that exhibit similar properties across nodes. As shown, record 908a includes a child node 904c that is structurally similar and corresponds to the same attribute type as child node 904f of record 908b (e.g., both are represented by a dashed line). Likewise, record 908a includes a child node 904d that corresponds to the same attribute type as child node 904g of record 908b (e.g., both are represented by a dotted line). Similarly, record 908e includes a child node 904c that corresponds to the same attribute type as child node 904h of record 908b (e.g., both are represented by a dash-dot-dot line). For example, child nodes 904c and 904f correspond to restaurant names, child nodes 904d and 904g correspond to addresses and child nodes 904e and 904h correspond to phone numbers for restaurant records. Of course, each record may not include all of the possible attributes of a particular list type. For instance, a particular restaurant record may not include a phone number for such restaurant.

The repeating and contiguous nature of sibling nodes can be utilized to determine the boundaries of each record. For example, since the first set of nodes 904c, 904d, and 904e have a pattern of attribute value types that correspond to a second set of nodes with the same pattern, the first set of nodes can be defined as a first record and the second set of nodes can be defined as a second record. The non-repetitive nodes at the header and footer of the sibling sequence can be defined as noise and not form part of the record list.

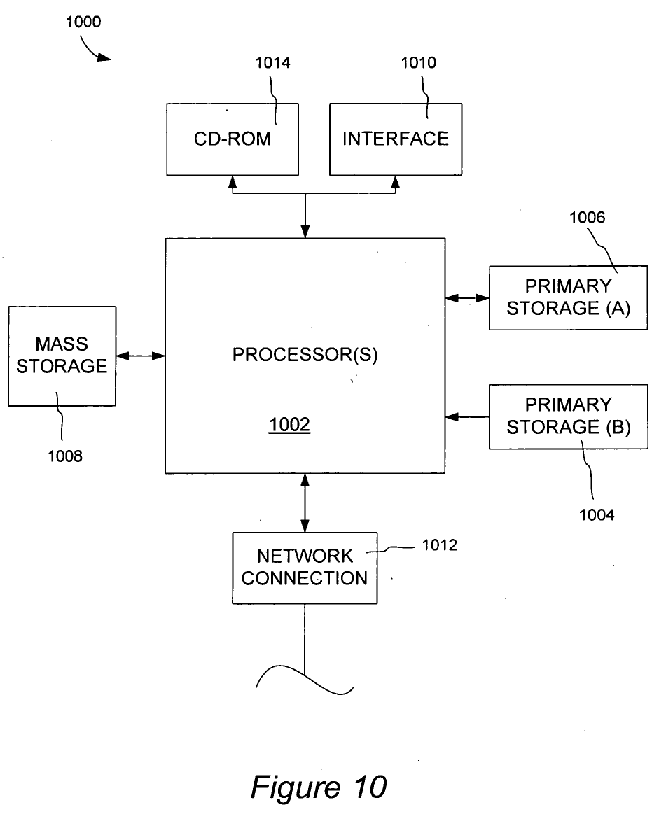

The techniques and system of the present invention may be implemented in any suitable hardware. FIG. 10 illustrates a typical computer system that, when appropriately configured or designed, can serve as a concept-centric extraction system. The computer system 1000 includes any number of processors 1002 (also referred to as central processing units, or CPUs) that are coupled to storage devices including primary storage 1006 (typically a random access memory, or RAM), primary storage 1004 (typically a read only memory, or ROM). CPU 1002 may be of various types including microcontrollers and microprocessors such as programmable devices (e.g., CPLDs and FPGAs) and unprogrammable devices such as gate array ASICs or general-purpose microprocessors. As is well known in the art, primary storage 1004 acts to transfer data and instructions uni-directionally to the CPU and primary storage 1006 is used typically to transfer data and instructions in a bi-directional manner. Both of these primary storage devices may include any suitable computer-readable media such as those described herein. A mass storage device 1008 is also coupled bi-directionally to CPU 1002 and provides additional data storage capacity and may include any of the computer-readable media described herein. Mass storage device 1008 may be used to store programs, data and the like and is typically a secondary storage medium such as a hard disk. It will be appreciated that the information retained within the mass storage device 1008, may, in appropriate cases, be incorporated in standard fashion as part of primary storage 1006 as virtual memory. A specific mass storage device such as a CD-ROM 1014 may also pass data uni-directionally to the CPU.

CPU 1002 is also coupled to an interface 1010 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1002 optionally may be coupled to an external device such as a database or a computer or telecommunications network using an external connection as shown generally at 1012. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store input instances, annotated input instances, concept schemes, domain knowledge, presentation rulesets, operators, annotations, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method of extracting structured information from web content, comprising:
representing web content of interest from a particular domain as one or more tree instances having a plurality of branching nodes that each correspond to a web object such that the tree instances correspond to one or more structured data instances, wherein the particular domain is associated with domain knowledge that includes one or more presentation rulesets that each specifies a particular structure for a set of data instances, a domain-specific concept labeler, one or more specified properties of the web objects in the tree instances, and a concept schema that specifies a representation of the data to be extracted from the web content;
extracting, from the one or more tree instances, a structured data instance that conforms to the concept schema based on the domain knowledge for the particular domain, wherein extraction of the structured data instances is accomplished by (i) using the domain-specific concept labeler to annotate a subset of nodes of the tree instances; and (ii) using a locally adaptive concept annotator to extract the structured data instances based on the annotated segments and the local properties associated with such annotated segments; and
storing the extracted structured data instance as structured output records in a database.

2. The method as recited in claim 1, wherein the concept schema corresponds to a labeled tree having a plurality of nodes representing named concepts and a plurality of leaf nodes representing atomic concepts.

3. The method as recited in claim 1, wherein the concept schema specifies one or more atomic concepts or attributes that form part of a particular entity record and the extracted structured data instances are in the form of a list of records that each have a plurality of attribute and value pairs.

4. The method as recited in claim 1, wherein the one or more presentation rulesets each specify hierarchical and ordering relations between instances of a plurality of presentation groups in the one or more tree instances that facilitate mapping of annotated atomic values to concepts in the concept schema.

5. The method as recited in claim 4, wherein the presentation rulesets are specified as a set of context-free grammars with respect to the one or more tree instances.

6. The method as recited in claim 1, wherein using the locally adaptive concept annotator is accomplished by:
generating a candidate pool of annotatable segments of the one or more tree instances for the concept schema;
identifying a set of predictive local features of the annotatable segments;
learning a model for a locally adaptive concept annotator based on the identified set of predictive local features and the annotated segments; and
executing the learned model on the candidate annotatable segments.

7. The method as recited in claim 1, wherein the extraction is accomplished by:
(a) choosing a set of selected informative queries for annotations;
(b) selecting and executing a current extraction operator from a plurality of operators for receiving the selected set of informative queries and producing a set of current annotations, wherein the selection of the current extraction operation is based on which operators have their input conditions met by a current annotated state of the tree instances and can produce the annotations of the selected informative queries;
(c) repeating operations (a) and (b) until a structured data instance that conforms to the concept schema is obtained.

8. An apparatus comprising at least a processor and a memory, wherein the processor and/or memory are configured to perform the following operations:
representing web content of interest from a particular domain as one or more tree instances having a plurality of branching nodes that each correspond to a web object such that the tree instances correspond to one or more structured data instances, wherein the particular domain is associated with domain knowledge that includes one or more presentation rulesets that each specifies a particular structure for a set of data instances, a domain-specific concept labeler, one or more specified properties of the web objects in the tree instances, and a concept schema that specifies a representation of the data to be extracted from the web content;
extracting, from the one or more tree instances, a structured data instance that conforms to the concept schema based on the domain knowledge for the particular domain, wherein extraction of the structured data instances is accomplished by (i) using the domain-specific concept labeler to annotate a subset of nodes of the tree instances; and (ii) using a locally adaptive concept annotator to extract the structured data instances based on the annotated segments and the local properties associated with such annotated segments; and
storing the extracted structured data instance as structured output records in a database.

9. The apparatus as recited in claim 8, wherein the concept schema corresponds to a labeled tree having a plurality of nodes representing named concepts and a plurality of leaf nodes representing atomic concepts.

10. The apparatus as recited in claim 8, wherein the concept schema specifies one or more atomic concepts or attributes that form part of a particular entity record and the extracted structured data instances are in the form of a list of records that each have a plurality of attribute and value pairs.

11. The apparatus as recited in claim 8, wherein the one or more presentation rulesets each specify hierarchical and ordering relations between instances of a plurality of presentation groups in the one or more tree instances that facilitate mapping of annotated atomic values to concepts in the concept schema.

12. The apparatus as recited in claim 11, wherein the presentation rulesets are specified as a set of context-free grammars with respect to the one or more tree instances.

13. The apparatus as recited in claim 8, wherein using the locally adaptive concept annotator is accomplished by:
generating a candidate pool of annotatable segments of the one or more tree instances for the concept schema;
identifying a set of predictive local features of the annotatable segments;
learning a model for a locally adaptive concept annotator based on the identified set of predictive local features and the annotated segments; and
executing the learned model on the candidate annotatable segments.

14. The apparatus as recited in claim 8, wherein the extraction is accomplished by:
(a) choosing a set of selected informative queries for annotations;
(b) selecting and executing a current extraction operator from a plurality of operators for receiving the selected set of informative queries and producing a set of current annotations, wherein the selection of the current extraction operation is based on which operators have their input conditions met by a current annotated state of the tree instances and can produce the annotations of the selected informative queries;
(c) repeating operations (a) and (b) until a structured data instance that conforms to the concept schema is obtained.

15. At least one computer readable storage medium having computer program instructions stored thereon that are arranged to perform the following operations:
representing web content of interest from a particular domain as one or more tree instances having a plurality of branching nodes that each correspond to a web object such that the tree instances correspond to one or more structured data instances, wherein the particular domain is associated with domain knowledge that includes one or more presentation rulesets that each specifies a particular structure for a set of data instances, a domain-specific concept labeler, one or more specified properties of the web objects in the tree instances, and a concept schema that specifies a representation of the data to be extracted from the web content;
extracting, from the one or more tree instances, a structured data instance that conforms to the concept schema based on the domain knowledge for the particular domain, wherein extraction of the structured data instances is accomplished by (i) using the domain-specific concept labeler to annotate a subset of nodes of the tree instances; and (ii) using a locally adaptive concept annotator to extract the structured data instances based on the annotated segments and the local properties associated with such annotated segments; and
storing the extracted structured data instance as structured output records in a database.

16. The least one computer readable storage medium as recited in claim 15, wherein the concept schema corresponds to a labeled tree having a plurality of nodes representing named concepts and a plurality of leaf nodes representing atomic concepts.

17. The least one computer readable storage medium as recited in claim 15, wherein the concept schema specifies one or more atomic concepts or attributes that form part of a particular entity record and the extracted structured data instances are in the form of a list of records that each have a plurality of attribute and value pairs.

18. The least one computer readable storage medium as recited in claim 15, wherein the one or more presentation rulesets each specify hierarchical and ordering relations between instances of a plurality of presentation groups in the one or more tree instances that facilitate mapping of annotated atomic values to concepts in the concept schema.

19. The least one computer readable storage medium as recited in claim 18 wherein the presentation rulesets are specified as a set of context-free grammars with respect to the one or more tree instances.

20. The least one computer readable storage medium as recited in claim 18, wherein using the locally adaptive concept annotator is accomplished by:
generating a candidate pool of annotatable segments of the one or more tree instances for the concept schema;
identifying a set of predictive local features of the annotatable segments;
learning a model for a locally adaptive concept annotator based on the identified set of predictive local features and the annotated segments; and
executing the learned model on the candidate annotatable segments.

21. The least one computer readable storage medium as recited in claim 18, wherein the extraction is accomplished by:
(a) choosing a set of selected informative queries for annotations;
(b) selecting and executing a current extraction operator from a plurality of operators for receiving the selected set of informative queries and producing a set of current annotations, wherein the selection of the current extraction operation is based on which operators have their input conditions met by a current annotated state of the tree instances and can produce the annotations of the selected informative queries;
(c) repeating operations (a) and (b) until a structured data instance that conforms to the concept schema is obtained.
